(19) United States
(12) Patent Application Publication
(10) Pub. No.: US 2026/0212328 A1
(43) Pub. Date: Jul. 23, 2026

(54) ACCESS TO APPLIANCE SPECIFIC SERVICES

(71) Applicant: ELECTROLUX APPLIANCES AKTIEBOLAG, Stockholm (SE)

(72) Inventors: Simon KARLSSON, Stockholm (SE); Allen SMITH, Stockholm (SE)

(73) Assignee: ELECTROLUX APPLIANCES AKTIEBOLAG, Stockholm (SE)

(21) Appl. No.: 19/140,840

(22) PCT Filed: Sep. 15, 2023
(86) PCT No.: PCT/EP2023/075515

§ 371 Date: Jun. 18, 2025

(30) Foreign Application Priority Data
Dec. 19, 2022 (GB) 2219176.1

(51) Int. Cl. G06Q 10/20; G06K 7/14

(52) U.S. Cl. CPC G06Q 10/20; G06K 7/1417

(57) ABSTRACT

A method of providing dynamic access to a user device to appliance specific service provided by an appliance service system is provided. The method may comprise receiving via an external communication unit of the appliance service system access data. The access data may comprise a unique identifier identifying an individual appliance. The method may further comprise storing in an access registering module of the appliance service system the event of an access to the appliance service system using the access data associated with the individual appliance and retrieving from the access registering module an access history using the access data associated with the individual appliance and providing access to a service level provided by the appliance service system to the user device in dependence on an access history using the access data associated with the individual appliance.

### FIELD OF THE INVENTION

The present invention relates to a method of providing dynamic access to a user device to appliance specific service provided by an appliance service system and to a computer program that performs such method. It further relates to a system for providing dynamic access to a user device to appliance specific service provided by an appliance service system.

### BACKGROUND

During the life-cycle of an appliance, various tasks may be needed which require a human-machine interaction process. In addition to the general operation of the appliance for its intended purpose, such as running a laundry cycle in a washing machine or turning on or adjusting the heating elements of a cooker, other technical tasks may also be required such as maintenance of the appliance, upgrade of the appliance and, for connected appliance, connection of the appliance to a network. Some of these tasks can extend the lifespan of the appliance and/or improve its performance and/or environmental impact. Generally, these tasks require some input by a user or technician and may also depend on technical data from the appliances and it can be difficult for users to know how to start and successfully complete the processes. More and more appliances on the market today are connectable to a network and controllable by user devices directly or via a cloud. Some technical tasks, new features and behaviors can be controlled or aided using such user devices.

Today an appliance is often equipped with a machine-readable label, e.g. a barcode, RFID or NFC tag that includes data comprising information that is related to the appliance. The amount of data that is storable on such kind of machine-readable label is inherently limited. For example, the maximum information content of a Quick Response (QR) code (177×177 elements, error correction level “L”) is 23,648 bits (2,956 bytes) which allows 7089 decimal digits or 4296 alphanumeric characters to be encoded. Due to the storage limitation, such a label often only contains data for a locator, identifier or tracker that points to a website or web service hosted by a server. The data may comprise for example a uniform resource locater (URL) which is an alphanumeric string of limited length. Storing the locator, identifier or tracker allows redirecting a device, e.g. a mobile phone, to the website when the label is read by the device. The amount of information obtainable by the device is then no more limited to the data capacity of the label but to the information provided by the server. The data included in a generated label is static, i.e. the data does not change after the label is generated. Accordingly, each time reading the label, the device is redirected to the same starting point on the website which contains the same information, e.g. a designated webpage, based on the static data. This limits the use of the label and makes it inflexible. Moreover, from that starting point, the relevant or desired information that motivated a user to read the label of the appliance has to be searched and the device has to navigate/has to be navigated to said relevant or desired information. For example, if the user wants to provision the appliance or run a maintenance procedure, the user may need to find a link to the manual and navigate to the correct part of the manual. Since it may be difficult or even unsuccessful for the user to identify and find the relevant or desired information, the processes may be interrupted or fail. This may result in increased computational load in the system, reduced performance, higher environmental impact, and/or shorter appliance life span. The above may also have drawbacks for user convenience when operating the appliance. For example, when the user searches for service information, the rather high effort of identifying and finding the relevant or desired information may result in reduced readiness to maintain the appliance or to perform adequate error handling and may therefore reduce the operation reliability of the appliance. Additionally, the searching as well as the navigating in order to identify and find the relevant or desired information may induce unnecessary traffic on server side.

### SUMMARY

Accordingly, there is the need to mitigate at least some of the drawbacks mentioned above and to improve user convenience and/or operation reliability of an appliance and, in particular, to improve how a server responds to a request that is based on reading a machine-readable label.

At least some of these needs are met by the features of the independent claims. The dependent claims describe embodiments of the invention.

According to an embodiment of the invention, a method of providing dynamic access to a user device to appliance specific service provided by an appliance service system is provided. The method may comprise receiving via an external communication unit of the appliance service system access data. The access data may comprise a unique identifier identifying an individual appliance. The method may further comprise storing in an access registering module of the appliance service system the event of an access to the appliance service system using the access data associated with the individual appliance and retrieving from the access registering module an access history using the access data associated with the individual appliance and providing access to a service level provided by the appliance service system to the user device in dependence on the access history using the access data associated with the individual appliance. The access history may include at least one out of the number of accesses using the access data and a time elapsed since a previous access using the access data.

The method bases the providing of appliance specific service to a user device on an access history that relates to an individual appliance that is uniquely identifiable by access data sent to and stored at the appliance service system. In dependence on data related to previous accesses which is stored by the appliance service system, the service level provided to the user device is modified or tailored to the user when the user (again) accesses the appliance service system. Accordingly, the user may be directly led to relevant or desired information.

By directing a user to relevant or desired information and human-machine interaction processes, unnecessary server traffic is reduced, and the user convenience is improved. Moreover, since the rather high effort of identifying and finding the information is eliminated or is at least reduced on user side, a user may initiate or perform adequate maintenance and error handling of the individual appliance without burden. Accordingly, the operation reliability of the appliance is improved.

Furthermore, the method implements a dynamic response of the appliance service system to received access data comprising static data, namely the unique identifier. For example, the access data may provide a single static input triggering dynamic routing to different technical processes depending on context, including at least one of the conditions of the appliance, age of the appliance and historical behavior of the user.

The access data may comprise data from reading a static machine-readable label, e.g. a barcode like a QR code or a RFID or NFC tag. Specifically, the access data may be provided by a query string of a URL that points to the appliance service system obtained from a QR code affixed or etched on the appliance. Since the appliance service system considers the access history of the individual appliance, (different) data is dynamically provided to the user device when the appliance service system receives a or a further request related to the individual appliance, although the initiation of the provision is based on static data. This overcomes the limitation and inflexibility of a machine-readable label and improves how a server responds to a request that is based on reading a machine-readable label.

It is moreover noted that the dynamic response increases the measure of surprise and, thus, the Shannon information of the access data or at least of the data provided in response to the received access data. E.g., since the access data may comprise data from reading a static machine-readable label, e.g., a barcode like a QR code or a RFID or NFC tag, the Shannon information of the machine-readable label or at least of the data that is provided in response to reading the machine-readable label is increased.

The access data may be comprised in an access request that is sent by a user device, e.g. a user access request.

The method is preferably performed by the appliance service system.

The individual appliance may be for example a dryer and/or a washer, a washer dryer, a dishwasher, an oven, a refrigerator and/or a freezer. The individual appliance is preferably a ‘unique’ appliance and is preferably a member of a serial model manufactured from one OEM manufacturer.

The user device may be for example a computer device, in particular a portable computer device as a mobile phone or smartphone or a tablet computer or the like.

The access data may comprise an access identifier or access code. It should be clear that the access data may comprise any type of data that may be used to identify the individual appliance, e.g. textual and/or custom binary data. For example, the access data may comprise data that represents a number or a sequence of letters or a mixture of both as for example a string of characters.

The access history may store any type of data/information associated with previous/past one or more accesses with which the appliance service system has been accessed using the access data associated with the individual appliance, e.g. the access history may store a time stamp for each access or a counter indicative of the number of accesses.

A module herein may for example comprise a data base comprising data that is retrievable by at least a portion of the received access data, e.g. the data base may exemplarily comprise a data dictionary comprising key-value pairs. The key may for example comprise at least the unique identifier and the value may for example comprise data stored in such module. For example, the access registering module may return in response to a given identifier (key) a value that comprises an access history of the individual appliance that is identifiable by the given unique identifier.

The external communication unit may comprise communication means configured to communicate, i.e. send, receive or exchange data, with one or more user devices. Preferably, the unit may further be configured to communicate with one or more individual appliances.

The service level may be comprised by plural service levels. The service levels may each successively provide more and/or more detailed service functionality (e.g., service procedure and/or service information). I.e., each higher service level may offer or enable more and/or more detailed service functionality. Some entrance service functionality may be skipped or removed from or disabled at a higher service level as compared to the lower service level. For example, individual appliance registration functionality and user/user device registration functionality may be removed when an individual appliance is already registered and user/user device is already registered, respectively. Alternatively or additionally, an order of providing the service functionality may be changed so that an order of providing the service functionality according to a higher service level differs from an order of providing the service functionality according to a lower service level. Preferably, access to a higher level/ranked service level may automatically include access to all lower ranked service levels.

Providing access to a service level provided by the appliance service system to the user may comprise transmitting data comprising information about one or more service procedures, in particular about a procedure step, and/or service information. Preferably, the transmitted data is displayable on the user device, in particular on a web browser or software application (APP) of the user device.

Providing access to a service level provided by the appliance service system to the user device may further be in dependence on status data of the individual appliance previously received in the appliance service system over a communication network from the individual appliance. The status data may comprise status about the condition of the appliance such as performance data and/or fault data. The service level may comprise providing status data for the appliance.

In an embodiment, providing access to a service level may comprise providing access to a first service level or providing access to a second service level in dependence on the access history using the access data associated with the individual appliance.

The first service level may comprise a computer implemented procedure for provisioning the appliance. Provisioning may include connecting the appliance to a network.

The second service level may comprise a computer implemented maintenance procedure for the individual appliance. In particular, the maintenance procedure may be provided based on status data of the individual appliance received over a communication network.

Providing access to the first or the second service level may comprise providing prioritized access to the provisioning procedure or to the maintenance procedure.

As such, the method may provide a human machine interaction process for connecting the appliance to a network and/or maintaining the appliance.

Alternatively, the first service level may comprise providing status data for the appliance. The second service level may then comprise also providing a maintenance procedure based on the status data.

According to an embodiment, service procedures and/or service information provided by the appliance service system as service level at the n-th time receiving the access data is different to the service level provided by the appliance service system at the m-th time receiving the access data, wherein m<n (where m and n are natural numbers ≥1).

According to an embodiment, the access data is received an n-th time with n>1 and the service level provided by the appliance service system is enabling one or more service procedures and/or service information that have not been provided at one of the previous times of receiving the access data, and/or disabling one or more service procedures and/or service information that have been provided at one of the previous times of receiving the access data.

Additionally or alternatively, the access data is received an n-th time with n>1 and one or more service procedures and/or service information are provided in a reordered order that differs from an order that has been provided at one of the previous times of receiving the access data in dependence on the service level provided by the appliance service system.

Disabling the one or more service procedures and/or service information may for example comprise that the one or more service procedures and/or service information are skipped/no more provided. For example, a step that has already been passed by the user device at one of the previous times of receiving the access data is skipped/no more provided such that (unnecessary) repetition is avoided.

Preferably, the disabled service procedures and/or service information are available at a current service level as an option which for example can be selected via optional menus or registers.

When the access data associated with the individual appliance was received the first time by the appliance service system, the appliance service system may provide access to one or more of the following service information or service procedures:
onboarding procedure for connecting the individual appliance to a communication network,
a registration procedure for registering the individual appliance,
first use information for the individual appliance,
a setup information for setting up the individual appliance,
an operation manual for the individual appliance,
a service manual for the individual appliance,
addresses of service for the individual appliance,
an accessory ordering platform, and
a consumables ordering platform.

The mentioned service information or service procedures may be relevant for the specific appliance type, as defined by appliance data in the access data.

When the access data associated with the individual appliance was received the second time by the appliance service system, the appliance service system may provide access to one or more of the following service information or service procedures:
warranty information,
extended use information for using the individual appliance,
information on optimized use of the appliance
a product recall platform for the individual appliance,
a maintenance platform providing prioritized repair service ordering and activation, and
information on accessories for the individual appliance.

When the access data associated with the individual appliance was received the third time or more than three times by the appliance service system, the appliance service system may provide access to one or more of the following service information or service procedures:
a warranty extension procedure,
information on appliance services to be provided by the user of the individual appliance,
information on consumables for the individual machine,
information on upgrading the individual appliance,
information on recycling the individual appliance,
information on selling the individual appliance, and
information on re-purchasing the individual appliance.

According to an embodiment, an indication of time of an access to the appliance service system is further stored in the access registering module of the appliance service system in addition to the event. The method may further comprise retrieving from the access registering module the frequency of times and/or the period since the last or first time the appliance service system was accessed using the access data associated with the individual appliance and providing service information or service procedures depending on the frequency of accesses and/or depending on the time period since the last or first access.

According to an embodiment, the method comprises, when the frequency of access is higher than a predetermined value, enabling one or more service procedures and/or service information that have not been provided at one of the previous times of sending the access data, and/or providing an information level to the user device according to an advanced user profile.

According to an embodiment, one or more service procedures and/or service information that have been provided at one of the previous times of sending the access data are disabled when the time period since the last or first access is higher than a predetermined value.

According to an embodiment, the service provided by the appliance service system to the user device includes a recommendation for ordering consumables or accessories for the individual appliance when the time period since the last or first access is higher than the predetermined value.

In an embodiment, the user device is provided with information relating to upgrading the individual appliance and/or information on re-purchasing the individual appliance when the time period since the first access is higher than a predetermined value.

Considering the indication of time allows more precisely tailoring the information provided to the user. For example, when the access data is received with a high frequency, the user may require more detailed information and, thus, further service procedures and/or service information is enabled. Vice versa, the provided information is reduced when the last or first access data has been sent more than a predetermined time ago.

According to an embodiment, the method further comprises determining whether the individual appliance is an appliance registered to a user associated with the user device in an individual appliance module of the appliance service system using the unique identifier for the individual appliance. The service level provided to the user device may be further dependent on the individual appliance being a registered appliance or not.

For the registration of the individual appliance, the user may have to pass an online registration process.

According to an embodiment, the method further comprises determining whether the individual appliance is an appliance connected via one or more communication networks (e.g., via a public communication network) to the external communication unit of the appliance service system. The service level provided to the user device may be further dependent on the individual appliance being a connected appliance or not.

The individual appliance may be connected to a communication network (e.g. it may be connected to a/the public communication network via a home communication network of the user) so that the machine can communicate with the appliance service system. Additionally or alternatively, the communication connection between the individual appliance and the appliance service system may be established over the user device. For this a communication connection between the user device and the individual appliance is established for example over Bluetooth or a home wireless local area network (WLAN).

Providing access to the service level may comprise providing access to a human-computer guided process for connecting the appliance to the appliance service system over a communication network.

Providing access to a service level in dependence on an access history may comprise providing access to an appliance provisioning process when the number of accesses is lower than a threshold and providing access to a maintenance process or a consumable replacement process when the number of accesses is equal to or higher than the threshold. The appliance provisioning process may comprise connecting the appliance to the appliance server system over a network. Providing access may comprise automatically starting a process or prompting a user to start a human-computer guided process.

In an embodiment, the method further comprises receiving via the external communication unit sensor data, and/or status data derived from sensor data, obtained from sensors of the individual appliance. The service level provided to the user device may be also dependent on the sensor data and/or the status data.

The status data may comprise an operation state of the individual appliance and/or an event such as information about a fault or an error code. This could for example relate to a condition of components of the appliance such as a clogged filter or a malfunctioning heating element, which deteriorates the level of performance or environmental impact of the appliance.

Providing the service level may comprise providing the user device access to the status data derived from the sensor data of the individual appliance. When the status data comprises an indication of an error/fault and/or performance issue, the service level may comprise a maintenance procedure associated with the error/fault and/or performance issue.

The maintenance procedure may comprise at least one of a diagnostic cycle, cleaning cycle, settings modification process and a software upgrade. In particular, the maintenance procedure is provided as an option or may be automatically run, when n>1.

The status data, and associated instructions, may prompt the user to interact with the appliance in a guided way for ensuring the proper function of the appliance and/or improving its performance and/or environmental impact or it may trigger an automatic maintenance procedure.

When the status data indicates an expired consumable, the service level may comprise a procedure for replacing the consumable, such as for example automatic ordering of a new consumable. The consumable could for example be an air or water filter. On a subsequent scan of the QR code, the system may provide access to a service level comprising a human-computer guided procedure for removing the used consumable and installing the new consumable.

The status data can also, or alternative, indicate the need for a spare part. For example, if the appliance is not operating as expected. The service level may then comprise a self-repair procedure, including an automatic or human-computer guided spare part ordering process and/or a human-computer guided process for replacing the existing part with the spare part.

This way, an error or a problem indicated by the sensor data or the indication of an error, e.g. by an error code reported by the appliance, is addressed without any burden for the user. Thus, the error or problem is faster addressed. Accordingly, the life of the appliance may be prolonged.

According to an embodiment, the method further comprises determining whether the user of the individual appliance is a registered user, registered in a user register module of the appliance service system. The service level provided to the user device may be further dependent on the user of the individual appliance being a registered user or not.

By providing different service levels, different information is provided to the user. E.g. if an appliance is already a registered appliance, information regarding a registration process are no longer provided. If the appliance is not registered only general information regarding the individual appliance may be provided such as service manuals. When the appliance is registered, more specific information such as e.g. a product recall for the individual appliance, or a residual warranty may be provided to the user. Thus, the user therefore only accesses information that is or can be relevant for him/her and his/her user device depending on whether the individual appliance is registered or not and if the appliance is registered, whether the appliance is connected or not connected to the appliance service system. Therefore, the user convenience and/or operation reliability of an appliance can be improved.

In an embodiment, the method comprises retrieving operation data, e.g. operation log data and/or operation status data, of the individual appliance. The service level provided to the user device may be further dependent on the operation data. The operation data may comprise data that is indicative of at least one of a date of first use of the individual appliance, a parameter set indicating a number of uses or total runtime of the individual appliance, data indicating a usage pattern of the individual appliance, data indicating a type and occurrence of error codes, a parameter indicating a number of users of the individual appliance, data indicating service events, like the last service, of the individual appliance (e.g. when and how many times serviced), data indicating a load or intensity in a current operation, a location or region of operation of the appliance and a parameter indicating a number of different locations or regions where the appliance has been operated. Preferably, before retrieving the operation data, operation data may be received by the appliance service system from the individual appliance, an external system and/or the or a user device and, optionally, stored at the appliance service system.

For example, the geographic information may be retrieved from the IP address of the device from which the access data is received. If for example the individual appliance is located in an area of high environmental humidity the user may be informed that an extremely low laundry humidity should not be selected due to ecologic reasons as (normally) the extremely over-dried laundry would bind air humidity and over-drying is not meaningful. Or if the water hardness is very low in the user's area an extra decalcifying agent would not be necessary for a washing machine's cycle.

In an embodiment, the method comprises retrieving individual appliance data of the individual appliance. The service level provided to the user device may be further dependent on the individual appliance data. The individual appliance data may comprise data that is indicative of at least one of an appliance identifier identifying the individual appliance (e.g., a unique serial number), a model identifier identifying the model group to which the individual appliance belongs, a market name of the individual appliance, an energy rating of the individual appliance, a manufacturing date of the individual appliance, a manufacturing place of the individual appliance and a date of registration of the individual appliance. Before retrieving the individual appliance data, individual appliance data may be received by the appliance service system from the individual appliance, a factory, a laboratory, a device belonging to a service technician and/or the user device and, optionally, stored at the appliance service system.

The individual appliance module may store the operation data and/or the individual appliance data retrievable by the unique identifier.

The access data may be received at the external communication unit of the appliance service system from the user device.

According to an embodiment, the user device may be adapted to read an information element provided at the appliance and to establish a communication channel to the external communication unit of the appliance service system based on the information read from the information element.

The access data may be generated by the user device by reading the information of an or the information element at the individual appliance. In particular, the unique identifier may be generated/derived from information read from the information element. Reading the information element may for example comprise scanning the information element.

The information element may for example comprise an optical code, e.g., a barcode, like a linear barcode or a matrix barcode as for example a QR code. Alternatively or additionally, the information element may comprise a RFID or NFC tag.

Preferably the access data is generated only by reading the information element by using the user device and more preferably, the access data additionally is generated by sending read information to the appliance service system. Preferably, for the sending (of the user access request) an active input of information by the user is not required.

A or the information element provided at the appliance may comprise one or more of the following:
an instruction set for causing the user device to establish a or the communication channel to the external communication unit of the appliance service system, wherein in particular the instruction set is an URL linking to the external communication unit of the appliance service system,
a serial number of the appliance,
a product number code of the appliance,
a model number of the appliance,
a maintenance level of the appliance,
manufacturing information,
appliance distribution information,
appliance connectivity information.

According to an embodiment, the access data received by the external communication unit of the appliance service system is formed by one or more of the following included in the information read from the information element:
a serial number of the appliance,
a product number code of the appliance,
a model number of the appliance,
a maintenance level of the appliance,
manufacturing information,
appliance distribution information,
appliance connectivity information.

According to an embodiment of the invention, a method of dynamically accessing appliance specific service provided by an appliance service system by a user device is provided. The method may comprise transmitting/sending, by the user device, access data to an external communication unit of the appliance service system. The access data may comprise a unique identifier identifying an individual appliance. The method may further comprise, in response to the transmitting/sending, getting access to the appliance specific service according to a service level provided by the appliance service system to the user device in dependence on an access history derived from the transmitted/sent access data. The access history may include at least one out of the number of accesses using the access data and a time elapsed since a previous access using the access data.

According to an embodiment of the invention, an appliance service system for providing dynamic access to a user device to appliance specific service is provided. The appliance service system may comprise a processing unit and an external communication unit, the external communication unit being configured to communicate with a user device and/or an individual appliance. In particular, the external communication unit may be configured to communicate over a public communication network. The appliance service system may be configured to perform a herein described method of providing dynamic access to a user device to appliance specific service provided by an appliance service system.

According to an embodiment of the invention, a user device for dynamically accessing appliance specific service provided by an appliance service system is provided. The user device may comprise a processing unit and a communication unit, the communication unit being configured to communicate with the appliance service system and/or the individual appliance. The user device may be configured to perform a method as described herein, in particular a or the method of dynamically accessing appliance specific service provided by an appliance service system by a user device.

According to an embodiment of the invention, an individual appliance is provided. The individual appliance is identifiable by a unique identifier and the identifier is transmittable to an external communication unit of an appliance service system in order to dynamically access appliance specific service provided by the appliance service system to a user device. Preferably, the individual appliance may comprise a processing unit and communication unit, the communication unit being configured to communicate with the appliance service system and/or the user device.

According to an embodiment of the invention, a system for providing dynamic access to a user device to appliance specific service provided by an appliance service system is provided. The system may comprise the appliance service system according to a or the appliance service system as described herein, in particular the appliance service system above (and as defined in the claims). The system may further comprise at least one of an individual appliance that preferably is communicatively coupled with the appliance service system and the user device being a herein described user device. When the system comprises the user device, the individual appliance may be, alternatively or additionally, communicatively coupled with the user device.

In some embodiments, the system provides Quick Response (QR) linking for Appliance Metadata and Services. In those embodiments, it utilizes a static QR Code to provide access to dynamic services, including dynamic content, based on product metadata.

According to an embodiment of the invention, a computer program for providing dynamic access to a user device to appliance specific service provided by an appliance service system is provided. The computer program comprises control instructions which, when executed by one or more processing units, cause the one or more processing units to perform a or the herein described method of providing dynamic access to a user device to appliance specific service provided by an appliance service system. The computer program may be provided on a volatile or non-volatile storage medium or data carrier.

According to an embodiment of the invention, a computer program for dynamically accessing appliance specific service provided by an appliance service system by a user device, wherein the computer program comprises control instructions which, when executed by one or more processing units, cause the one or more processing units to perform a or the herein described method of dynamically accessing appliance specific service provided by an appliance service system by a user device. The computer program may be provided on a volatile or non-volatile storage medium or data carrier.

The or each processing unit may for example include a digital signal processor, an application specific integrated circuit, a field programmable gate array, a microprocessor or the like. The one or more processing units may cooperate with at least one memory unit. The memory unit may include RAM, ROM, Flash Memory, a hard disk drive and the like. Moreover, the memory unit may for example comprise a cloud storage. In such example, the memory unit or at least a part of the memory unit may be arranged at a site different from a site at which at least one of the one or more processing units is arranged.

It is to be understood that the features mentioned above and those yet to be explained below can be used not only in the respective combinations indicated, but also in other combinations or in isolation, without leaving the scope of the present invention. In particular, the features of the different aspects and embodiments of the invention can be combined with each other unless noted to the contrary.

It should be clear that all method features or functional features are without limitation applicable as a single feature, as a combination of features, or in any sub-combination in a device or system described herein and are disclosed hereby. Likewise, all device or system features or structural features are without limitation applicable as a single feature, as a combination of features, or in any sub-combination to a method described herein and are disclosed hereby.

It should further be clear that the sequence of method steps of a method described herein is not limited to the sequence shown. Further, the method is not limited to the number of steps shown. Individual steps of the method may be substituted, extended or not performed.

### BRIEF DESCRIPTION OF THE DRAWINGS

The foregoing and other features and advantages of the invention will become further apparent from the following detailed description read in conjunction with the accompanying drawings. In the drawings, like reference numerals refer to like elements.

FIG. 1 is a schematic illustration of a system for providing dynamic access to a user device to appliance specific service provided by an appliance service system according to an embodiment and of an exemplary communication structure of the system.

FIG. 2 is a schematic illustration of the appliance service system of FIG. 1 according to an embodiment.

FIG. 3 is a schematic flow diagram illustrating a method of providing dynamic access to a user device to appliance specific service provided by an appliance service system according to an embodiment and a method of dynamically accessing appliance specific service provided by an appliance service system by a user device according to an embodiment.

FIG. 4 is a schematic flow diagram illustrating a specific example of the routing procedure to a number of different exemplary service levels provided by the appliance service system.

### DETAILED DESCRIPTION

In the following, embodiments of the invention will be described in detail with reference to the accompanying drawings. It is to be understood that the following description of the embodiments is given only for the purpose of illustration and is not to be taken in a limiting sense. It should be noted that the drawings are to be regarded as being schematic representations only, and elements in the drawings are not necessarily to scale with each other. Rather, the representation of the various elements is chosen such that their function and general purpose become apparent to a person skilled in the art. As used herein, the singular forms “a,” “an,” and “the” are intended to include the plural forms as well, unless the context clearly indicates otherwise. The terms “comprising,” “having,” “including,” and “containing” are to be construed as open-ended terms (i.e., meaning “including, but not limited to,”) unless otherwise noted.

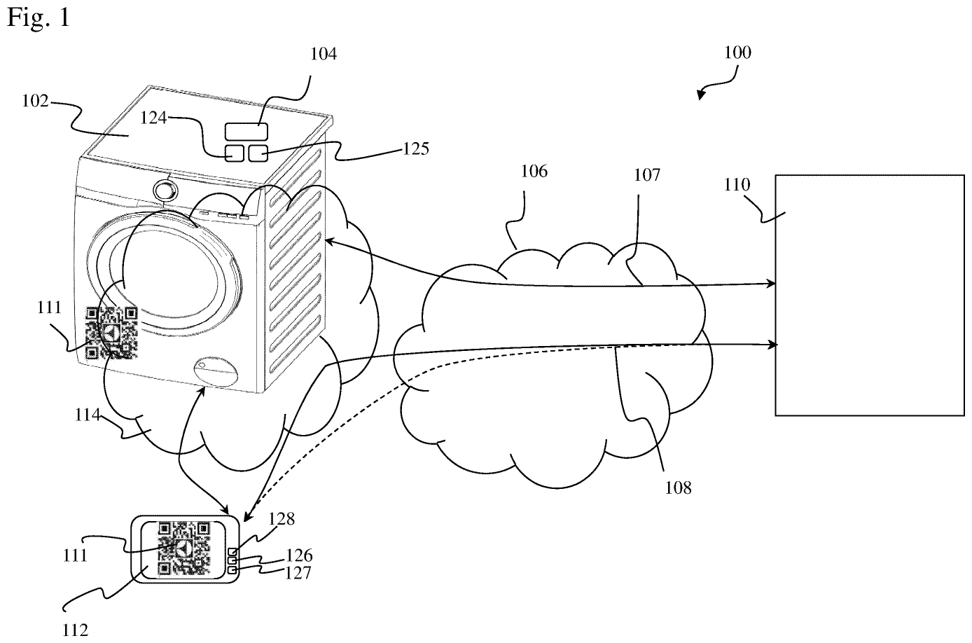

FIG. 1 is a schematic illustration of a system 100 for providing dynamic access to a user device 112 to appliance specific service provided by an appliance service system 110 according to an embodiment and of an exemplary communication structure of the system 100. An individual appliance 102 comprises a processing unit 124 and a memory unit 125. The appliance 102 further comprises a communication unit 104. The communication unit 104 may optionally be in communication with the appliance service system 110 via a (first) communication channel 107. The first communication channel may be provided over a communication network 106, e.g. a public communication network. For this purpose, the individual appliance 102 may be connected to the appliance service system 110 via a wireless communication network and/or via a home WLAN and a router to the Internet (e.g. the below home network 114). In other words, the appliance 102 may for example be configured to exchange (directly) data with the appliance service system 110 using home network 114 and public communication network 106. In another example, the data may be (indirectly) exchangeable with the appliance service system 110 by means of a user device 112.

The individual appliance 102 may provide individual appliance data and/or operation data, e.g. operation log data and/or operation status data, of the appliance 102 to the appliance service system 110. The data may comprise sensor data that is obtained from sensors of the individual appliance 102 and/or status data derived from the obtained sensor data. Data provided from the appliance 102 to the appliance service system 110 may be stored in the appliance service system 110.

Although a first communication channel has been shown in FIG. 1, in some implementations the individual appliance may not have a communication unit 104 and may not be able to communicate over a first communication channel with the appliance service system or the user may be able to turn off the communication unit, or disable settings permitting the individual appliance to send data over the first communication channel. The appliance may be arranged such that communication over the first communication channel may be enabled, via a user interface and/or via instructions from the appliance service system, to make the appliance a “connected” appliance.

The system 100 comprises the user device 112 (e.g. a mobile phone or a tablet or the like). The user device 112 comprises a processing unit 126 and a memory unit 127 and a communication unit 128. The communication unit 128 is in communication with the appliance service system 110 via a second communication channel 108. For this purpose, the user device 112 may be connected to the appliance service system 110 via a wireless communication network and/or via a home WLAN (e.g., the home network 114) and a router to the Internet. The communication channel 108 may alternatively be implemented as a connection using wireless communication for mobile devices such as 4G, 5G, or LTE, as exemplarily indicated by the dashed line that bypasses home network 114.

The user device 112 may also be directly connected to the individual appliance 102 via the home network 114. The user device 112 and the individual appliance 102 may be in communication via the home network 114 e.g. by using Bluetooth, WLAN or a 5G femtocell.

The individual appliance data and/or operation data of the appliance 102 may be transmitted from the appliance 102 to the appliance service system 110 over the first communication path. However, in other implementations, or in some circumstances, it may be provided to the appliance service system 110 via the user device 112 and the second communication channel 108. In other words, individual appliance data and/or operation data may be sent from the individual appliance 102 to the user device 112 and from user device 112 to appliance service system 110.

The user device 112 may be used as a reader for scanning an information element 111 comprised by the individual appliance 102 or arranged at the individual appliance 102. In particular, a unique identifier is generated based on data scanned or read from the information element 111. The information element 111 may for example comprise an optical code, e.g., a barcode, like a linear barcode or a matrix barcode as for example a Quick Response (QR) code. Alternatively or additionally, the information element may comprise a RFID or NFC tag. Accordingly, the user device 112 may comprise a reading unit configured to scan the information element 111 such as a camera and/or a RFID or NFC reader. The information element 111 may be arranged at the outer housing of the appliance 102 or at a location accessible by a user without disassembling the appliance, e.g. at the inside of an appliance door or a door frame. The information element may be arranged next or integrated with an appliance label identifying and individualizing the appliance. The information element could be provided as a sticker or etched on the housing or a door of the appliance. Alternatively, it could be generated by the processing unit and displayed on a display (not shown in FIG. 1) of the appliance 102. The information element 111 may include one or more out of a serial number of the appliance, a product number of the appliance, a model number of the appliance, a maintenance level of the appliance, manufacturing information about the appliance and appliance distribution information. It may also comprise appliance connectivity information such as information about whether the appliance is a connectable appliance. One or more of these may uniquely identify the appliance. For example, one or more of these may provide the unique identifier or may be used to derive a unique identifier.

As will be described in more detail below, (user) access data comprising at least the unique identifier is sent via second communication channel 108 from the user device 112 to the appliance service system 110. The sending of access data may be initiated by selecting an option, such as pressing or clicking e.g. a virtual button or icon, in a graphical user interface of an application deployed on the user device 112 or, alternatively, is automatically performed in response to scanning the information element 111. The sent access data is received at the appliance service system 110. Since unique data that is linked to the individual appliance 102 is included in the sent access data, the appliance service system 110 may identify the individual appliance 102, i.e. the appliance to which the sent request relates, based on the sent access data. For sending the access data, a user may not be required to actively input information. Preferably, the only activity performed by the user is scanning or reading of the information element 111 by means of user device 112 and/or causing the sending of the scanned information to the appliance service system 110.

For example, the access data including the unique identifier may be sent based on a TCP/IP protocol. In particular, the unique identifier is a unique alphanumeric character sequence or string and may be included as a parameter in a query string of a URL that points to the appliance service system 110. The parameter may be encrypted using public-key cryptography.

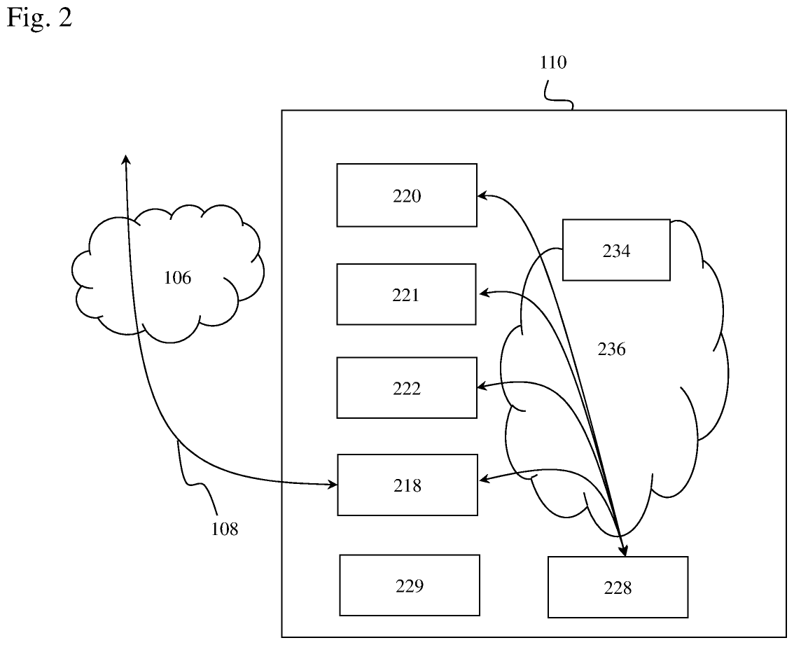

FIG. 2 is a schematic illustration of the appliance service system 110 of FIG. 1 according to an embodiment.

As mentioned above, the access data is transmitted via second communication channel 108 to the appliance service system 110. The access data may be received as a user access request at an external communication unit 218. The external communication unit 218 may further be used to respond to the user device, i.e. to transmit or send the required data to provide access to the user device to appliance specific service.

The appliance service system 110 may comprise a processing unit 228 and a memory unit 229. The processing unit 228 may be used for handling the access data, retrieving, storing and/or routing data. Handling the access data may comprise extracting the unique identifier from the received access data and, based on the identifier, identifying the individual appliance that is uniquely associated with the identifier.

The appliance service system 110 may further comprise an access registering module 220, an individual appliance module 221 and a user register module 222. The access registering module 220 may store data related to one or more previous accesses that are associated with the individual appliance 102, the data being retrievable using the access data and in particular using the unique identifier. For example, the access registering module 220 may retrievably store data indicative of an access event each time when the appliance service system 110 is accessed using access data associated with the individual appliance 102. The stored data may comprise an indication of time for each stored event.

Accordingly, based on the received access data and in particular the unique identifier, an access history may be retrieved from the access registering module 220 that includes at least one out of the number of accesses, a time elapsed since a previous access and a frequency of accesses. The frequency of accesses may be derived based on at least two stored access events. The service level that is provided to the user device 112 may be dependent on the data retrieved from the access registering module 220.

The individual appliance module 221 may store individual appliance data including information about the appliance such as one or more of a model identifier identifying the model group to which the individual appliance belongs, a market name of the individual appliance, an energy rating of the individual appliance, a manufacturing date of the individual appliance and a manufacturing place of the individual appliance. It may alternative or additional include one or more of a parameter indicating a number of users of the individual appliance, data indicating service events, like the last service, of the individual appliance (e.g., when and how many times serviced), a location or region of operation of the appliance and a parameter indicating a number of different locations or regions where the appliance has been operated. The individual appliance data may be received by the appliance service system from the individual appliance, a factory, a laboratory, a service technician device and/or the user device and, optionally, stored at the appliance service system.

The individual appliance module 221 may also store data that is indicative of whether the individual appliance is a registered appliance or not. This could for example be the date of registration. The individual appliance module 221 may further store an indication of whether the individual appliance is a connected and/or connectable appliance. In other words, the individual appliance may store data indicating whether the appliance is able to communicate over a first communication channel and whether it has, in fact, been enabled to communicate over that channel. If the individual appliance is a connected appliance and the appliance service system has received operational data from the individual appliance, such as sensor, log and/or status data, the individual appliance module 221 may additionally store the operational data received from the individual appliance data. The operational data may comprise, but is not limited to, data that is indicative of at least one of a date of first use of the individual appliance, a parameter set indicating a number of uses or total runtime of the individual appliance, data indicating a usage pattern of the individual appliance, data indicating a type and occurrence of error codes and data indicating a load or intensity in a current operation. Similar to the access registering module 220, the stored data may be retrievable by the access data and in particular by the unique identifier. The service level that is provided to the user device 112 may be further dependent on the data retrieved from the individual appliance module 220.

The user register module 222 may store data that is indicative of whether the user of the individual appliance is a registered user or not. Similar to the access registering module 220, the stored data may be retrievable by the access data and in particular by the unique identifier. The service level that is provided to the user device 112 may be further dependent on the data retrieved from the user register module 222.

As said, the processing unit 228 may be configured to retrieve previously stored data from the modules 220, 221, 222 based on the received access data and in particular based at least on the unique identifier. Accordingly, the processing unit 228 may be configured to cause the modules to store data received from the user device 112 and/or received from the appliance 102. The data may be stored such that it is linked to the unique identifier/individual appliance and, thus, again retrievable using the identifier, e.g. by a data dictionary comprising respective key/value pairs.

Further, the processing unit 228 may be configured to provide access to the user device 112 to appliance specific service according to a service level that is determined based at least on the received access data and/or the stored data retrieved from modules 220, 221, 222. The service levels may include, but are not limited to, provisioning procedures, maintenance procedures, consumable replacement procedures, registration procedures, user manual access information, first use information and/or setup information. At least some of these procedures may be provided as human-computer guided procedures. Each service level may comprise a subset of these procedures or information and/or it may present some of the procedures in a prioritized manner, such as automatically starting or prompting the user to engage in one of the human-computer guided procedures while providing other procedures and/or information as options that the user can navigate to if desired by the user. Some of the procedures or links to information may be removed or disabled from some service levels. Thus, the user is provided only with tailored information that is relevant for the appliance 102 and/or for the user of user device 112. E.g., if information is stored in the individual appliance module 221 indicating that the individual appliance 102 is already provisioned and registered, steps for provisioning and registration of the appliance, using the first and/or the second communication channel, are removed or disabled when access data is received by the appliance service system 110.

The appliance service system 110 may further be configured to identify the requesting user and/or the requesting user device. A registered user may be identified by identifying information sent by user device 112. Thereby access to additional information of the user may be permitted at the appliance service system 110. The service level that is provided to the user device 112 may be further dependent on whether the user and/or the device 112 is a registered user and/or device or not. For example, if the user is not a registered user, the service level may include a prompt and/or guided human-computer process to register as a user. If the user is a registered user but the appliance is not a registered appliance, the service level provided to the user device may include a prompt and/or guided human-computer process to register the appliance to the user. The processes may involve the user sending identifying information, for the user and/or the appliance, via the second communication channel to the appliance server system, and the appliance server system storing this information in the relevant modules described above. The identifying information for the appliance may be extracted from the information obtained by scanning the information element 111 and the user may not need to enter any further information for identifying the appliance, thereby reducing the risk of input errors and the registration process failing. As mentioned above, these processes may be disabled or removed from the service level when the processes have been completed. For security reasons, access to additional information of the user may only be provided if the access request originated using an App, associated with the manufacturer of the appliance, to which a user has already logged in. The identifying information may be a username and password sent when the user logged into the App. However, identifying information may also be the Internet Service Provider (ISP) address of the user device and/or geolocation of the user device.

In an embodiment, each module herein may be associated with a server for storing the information of each module. For example, several modules may share the same server or each module is associated with a different server. One or more modules may also be distributed over a plurality of servers. In one implementation, the modules are provided as part of a cloud providing remote data storage and processing services via a communication network. In some implementations, at least one of the modules and the associated server may be external to the appliance service system 110. In any case, the processing unit 228 is configured to obtain the required information or data based on the received access data and in particular based on the unique identifier from such a server, e.g. by sending a data request to such server so that the server responds by sending the requested data. The processing unit 228 may retrieve information of modules which are not comprised in the appliance service system 110 via a connection to the Internet.

Within the appliance service system 110, the flow of information between the different modules and from/to the processing unit 228 may be controlled by the internal communication unit 234 using, e.g., a data bus system in a stand-alone server and/or using a private communication network 236. The private communication network 236 may be, e.g., an Intranet which is only accessible by authenticated server modules (e.g. the modules shown in FIG. 2) and authorized users.

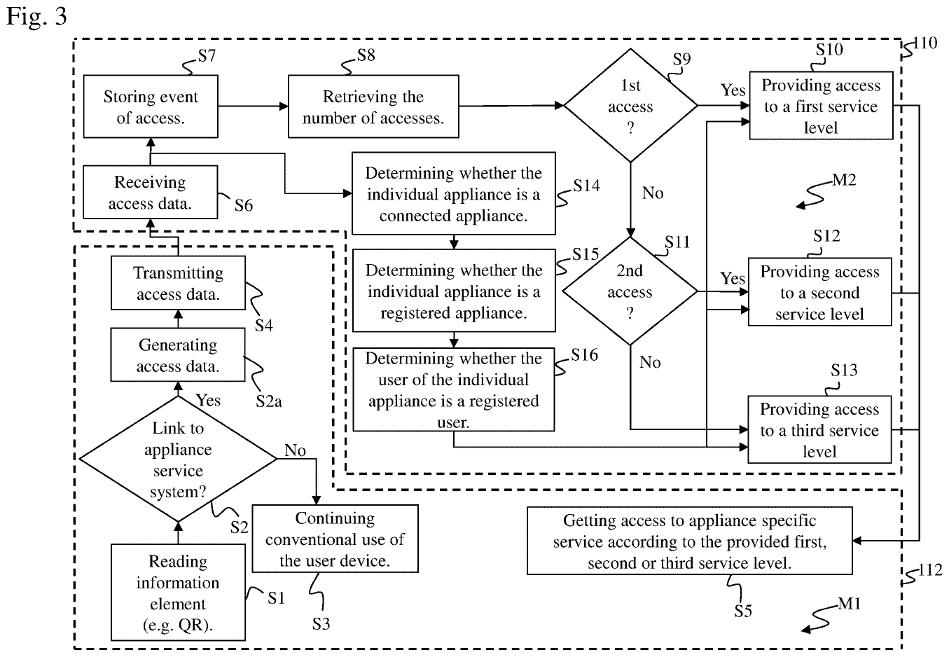

FIG. 3 is a schematic flow diagram illustrating a method M2 of providing dynamic access to a user device to appliance specific service provided by an appliance service system according to an embodiment and a method M1 of dynamically accessing appliance specific service provided by an appliance service system by a user device. The method M2 may be performed by the appliance service system 110 and/or the method M1 may be performed by the user device 112.

In an embodiment, the method M1 may comprise the method steps S1-S5. In the step S1, an information element provided at the individual appliance is read or scanned. In a step S2, it is determined whether the read data includes a link to the appliance service system. When the link is not included, a conventional use of the user device is continued (step S3). When the link is included, access data may be generated based on the data read from the information element (step S2a). A unique identifier which identifies the individual appliance and that is included in the access data may be generated from the information read from the information element. In the step S4, the generated access data is transmitted/sent to the appliance service system. Optionally, before step S4, a step of establishing a communication channel to an external communication unit of the appliance service system based on the information read from the information element is performed. According to step S5, the method further comprises, in response to the transmitting/sending (step S4), getting access to the appliance specific service according to a or one service level provided by the appliance service system to the user device in dependence on an access history derived from the transmitted/sent access data. The access history may include at least one out of the number of accesses using the access data and a time elapsed since a previous access using the access data.

In an embodiment, the method M2 may comprise the method steps S6-S16. The step S6 may comprise receiving via an external communication unit of the appliance service system the access data comprising the unique identifier based on which the individual appliance is identifiable. The step S7 may comprise storing in an access registering module of the appliance service system the event of an access to the appliance service system using the access data associated with the individual appliance. The step S8 may comprise retrieving from the access registering module the number of times the appliance service system was accessed using the access data associated with the individual appliance. Based on the retrieved number of times, it is determined in step S9 and if necessary, in step S10 whether the current access is a first, second, or third or subsequent access. When it is determined that the current access is the first access, it is continued with step S10 and steps S12 and S13 are not performed. In step S10, access to a first service level is provided. When it is determined that the current access is the second access, it is continued with step S12 and the steps S10 and S13 are not performed. In step S12, access to a second service level is provided.

When it is determined that the current access is the third access or an access subsequent of the third access, it is continued with step S13 and the steps S10 and S12 are not performed. In step S13, access to a third service level is provided. It should be clear that the limitation to the number of three is only an example from which other embodiments of method M2 may differ. The step S14 may comprise determining whether the individual appliance is an appliance connected, or at least connectable, via a public communication network to the external communication unit of the appliance service system. The step S15 may comprise determining whether the individual appliance is an appliance registered to a user associated with the user device in an individual appliance module of the appliance service system using the unique identifier for the individual appliance. The step S16 may comprise determining whether the user of the individual appliance is a registered user registered in a user register module of the appliance service system. Independently of which of steps S10, S12, S13 is performed, the service level provided to the user device may be further dependent on the determining S14 whether the individual appliance is a connected appliance or not, on the determining S15 whether the individual appliance is a registered appliance or not and on the determining S16 whether the user of the individual appliance (102) being a registered user or not. The step of providing access S10, S12, S13 may further be dependent on an indication of time that is elapsed since a previous access.

For example, as indicated herein already, if the appliance 102 is not a registered appliance and/or the user is not a registered user, the service level may include a prompt, guided procedures and/or information about how to register the appliance in a prioritized manner. However, if the access history indicates that the user has used the appliance 102 for a long time without registering it, i.e. if a number of years has elapsed since the first or most recent access using the access data, the service level may not prioritize the registration procedure but may prioritize access to trouble shooting information in the product manual, maintenance procedures and consumable ordering procedures instead. If the appliance 102 is not a connected appliance, but it is determined that the appliance is a connectable appliance, the service level may include a human machine guided procedure to download an App associated with the manufacturer, turning on the appliance 102 and starting a provisioning process. However, as above, if the time elapsed since the last or first access is longer than a time t, which may for example be 3, 4, 5 or 10 years but could be any appropriate time period, the system may determine that the user is not interested in connecting the appliance and may provide access to the trouble shooting information, maintenance processes or consumable ordering information. It may also provide a link to the provisioning procedures as a de-prioritized option, e.g. towards the end of a list of options. Determining that an appliance is connectable may involve checking connectivity data indicating whether the appliance is a connectable appliance stored in the individual appliance module 221 or checking whether the model number associated with the individual appliance included in the access data, or associated with the unique identifier in the access data, is for a connectable appliance. In some implementations, the information element 111 and the access data may comprise connectivity information specifically indicating whether the appliance is connectable or not. This avoids the need to check if the unique identifier or model number is associated with a connectable appliance and improves processing speeds. If the appliance 102 is already provisioned and connected, the service level may comprise displaying appliance status data to the user. This may involve launching the App associated with the manufacturer and displaying the product state, including sensor data received as described herein, in the App. If the access history indicates that the number of accesses using the access data is larger than a number n and/or the time elapsed since the first or the most recent access is larger than t, the appliance service system 110 may further analyze status data associated with the individual appliance and, check if the appliance 102 is reporting an error or expired consumable and provide access to a service level based on the findings. For example, this could include, in addition to showing the product status, automatic commencement or prompts to commence a diagnostic cycle, launch of chat bots or prompts to start a phone call with product or customer support, or automatic or guided ordering of new consumables. In some implementations and/or in some circumstances, the service system may consider both the number of accesses and the time elapsed since the first or the most recent access to provide tailored data since if the user has scanned the QR code a large number of times but all of them occurred within a 24 hour period it is likely to indicate that the user is merely exploring the system and not that the user is at a later stage in the appliance life cycle.

As indicated herein, each service level may comprise one or more automatically triggered or human-machine guided procedures. For example, a service level could comprise a series of GUI screens communicated to the user device in a specific order with each screen including prompts or options for procedures to follow. For example, the prompts could be prompts to confirm that the system can instruct the appliance to perform a number of tasks. Each service level may additionally or alternatively include a number or links to further information, again displayed in a prioritized format based on the access history.

As a specific example, providing access to a service level in dependence on an access history may comprise providing access to an appliance provisioning process when the number of accesses is lower than a threshold and providing access to a different technical process, such as a maintenance process or a consumable replacement process, when the number of accesses is equal to or higher than the threshold. Alternatively, it could include providing access to product state information when the number of accesses is lower than a threshold and providing access to product state information but also providing access to a maintenance process based on an analysis of the product state information, when the number of accesses is equal to or higher than the threshold. Providing access to a process may comprise automatically starting a process or prompting a user to start a human-machine guided process. Prompting a user to start the guided process may comprise displaying, as the first or one of the first screens in a series of screens communicated to the user device 112 in a specific order as part of the service level, a prompt to the user to confirm that the process should be started. Prompting the user to start the guided process may alternatively comprise displaying an option to start the process in a prioritized manner to the user, such as first in the list of a plurality of options.

A maintenance process may comprise, but is not limited to, a cleaning process, a diagnostic process or a software upgrade process, provided as a human machine guided procedure based on appliance condition data received from sensors. A consumable replacement process may comprise a human machine guided process comprises ordering a consumable and providing instructions on how to remove the expired consumable and install the new one. The instructions may be provided based on sensor data received from the appliance 102. In some implementations, the user is prompted to confirm that the consumable should be ordered. Later, for example on a subsequent access attempt or on notification in the system that the consumable has been delivered, the user may be prompted to start the installation process and may be guided based on individual appliance sensor data received in the system.

A provisioning procedure may comprise a human machine guided process for connecting the appliance 102 to a network, such as the home network 114 and/or communication network 106 in FIG. 1, and then connecting the appliance over the network to the appliance service system 110. On first or second scan, the human machine guided process for connecting the appliance 102 to the network may be the first or one of the first processes offered to the user in an ordered process or the process may be automatically started. On subsequent scans, or more generally when the number of the scan is higher than a threshold number t, the process may merely be offered as an option selectable by a user. The human-machine guided process may comprise automatically or on confirmation by the user using a user interface of the user device 112, causing the user device 112 to communicate directly with the appliance 102, for example over a short-range communication network, to obtain a list of networks accessible by the appliance 102, sending credentials for accessing a selected network and sending an indication of address data for allowing the appliance 102 to connect to the appliance service system 110 via the selected network. Causing the user device 112 to communicate directly with the appliance could comprise prompting and guiding the user to download, or launch, software such as an App associated with the manufacturer of the appliance storing software instructions for provisioning the appliance, including instructions for communicating directly with the appliance 102, and to turn on a short-range communication interface of the appliance 102.

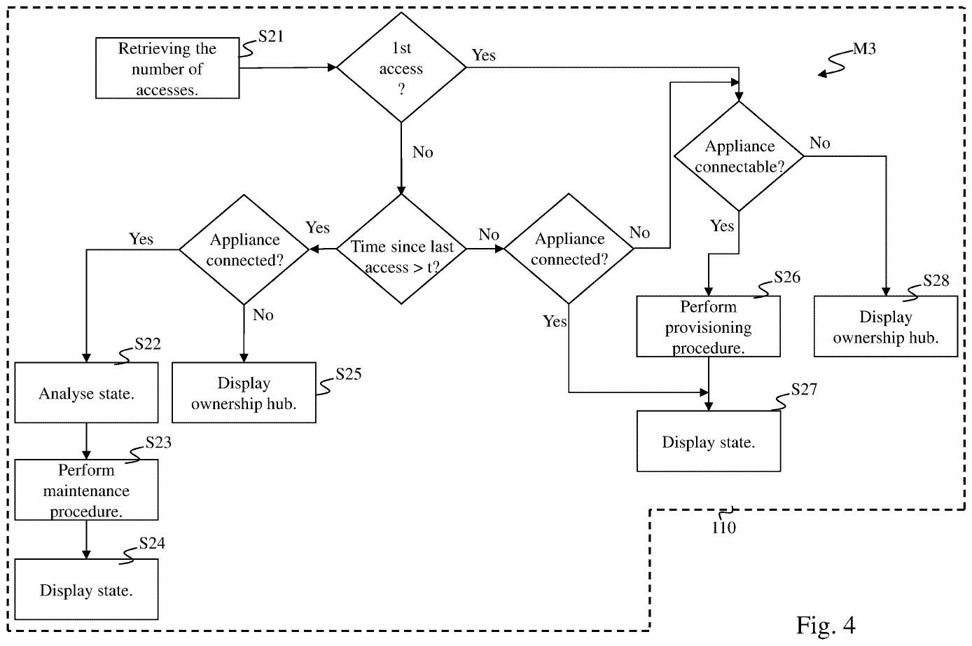

One specific example of dynamic routing of an access request to a provision process/provision procedure or a maintenance process/maintenance procedure is illustrated in FIG. 4. It will be realized that this is just one specific examples and variations, and modifications are possible. Some processes, such as user and appliance registration, have been left out of the flow diagram of FIG. 4 to improve clarity. In some implementations, user and appliance registration could be provided as part of all or some of the service levels of FIG. 4, if appropriate.

Accordingly, FIG. 4 shows a schematic flow diagram illustrating the specific example of the routing procedure (method M3) to a number of different exemplary service levels provided by the appliance service system 110. In a step S21, the method M3 may comprise retrieving (from the access registering module) the number of times the appliance service system 110 was accessed using the access data associated with the individual appliance 102. Based on the retrieved number of accesses, it may be determined whether the current access is a first or a subsequent (at least a second) access.

When the appliance system 110 is accessed the first time, it may be determined whether the appliance 102 is connectable/is a connectable device. When the appliance 102 is connectable, a provisioning procedure may be performed in a step S26 and an (updated) state may be displayed on user device 112 in a step S27. Instead, when the appliance is not connectable, an ownership hub may be displayed on user device 112 in a step S28.

The ownership hub may for example be a hub or collection of content that is relevant to the user. The content could for example be organized and communicated in dependence on the access history, e.g., based on the number of accesses and/or the time passed since the last access, different content and/or a different organization of the content may be shown.

When the appliance system is accessed for at least a second time, it may be determined whether the time since the last access, e.g., since the last time information element 111 has been scanned, exceeds a threshold t.

By determining whether the time since the last access is above a threshold, the system can provide a relevant service level to a user. If it is determined for example that the number of access has exceeded ten times in 24 h, it is likely that the user is only testing the access functionality and that the user may still be interested in connecting their connectable appliance. On the contrary, if it was a number of years since the last access request it is more likely that the user is satisfied with the non-connected use of the appliance and is after information in the ownership hub. In such a case, the appliance service system may not offer a provisioning procedure in prioritized manner. As a specific example, the threshold time period t in FIG. 4 could for example be 1 week, 1 month or 1 year. The appliance service system may comprise a rules engine, with access to updatable time threshold in memory, for navigating a decision tree that provides different services levels based on the access history.

Referring again to FIG. 4, it may be determined whether the appliance 102 is connected to the appliance service system 110 when the threshold is exceeded. When the appliance 102 is connected, a state of the appliance 102 may be analyzed in a step S22, a maintenance procedure may be performed in a step S23 and an (updated) state may be displayed on user device 112 in a step S24. Instead, when the appliance 102 is not connected, the ownership hub may be displayed on user device 112 in a step S25.

When the threshold is not exceeded, it may also be determined whether the appliance 102 is connected to the appliance service system 110. When the appliance 102 is connected, the state of the appliance 102 may be displayed in a step S27. Instead, when the appliance 102 is not connected, either the steps S26 and S27 are performed or the step S28 is performed in dependence on whether it is determined that the appliance 102 is connectable/a connectable device.

While specific embodiments are disclosed herein, various changes and modifications can be made without departing from the scope of the invention. The present embodiments are to be considered in all respects as illustrative and non-restrictive, and all changes coming within the meaning and equivalency range of the appended claims are intended to be embraced therein.

For example, while the first communication channel 107 connecting the appliance 102 and the appliance service system 110 and the second communication channel 108 connecting the user device 112 and the appliance service system 110 have been described to include a public communication network, it should be realized that the first and second communication channels 107, 108 could be implemented in any suitable way. One or both of the channels 107, 108 could include cellular networks.

Although it has been described that the QR code or other information element for providing the access data is provided on a sticker or etched on the appliance, the QR code or other information element could be provided on a display of the appliance 102. In some implementations, it may not be static but dynamically generated when needed. Although it has been described that, in some implementations, access to a service level is provided based on access history and status data, in other implementations or in some circumstances access to a service level may be provided based on status data only.

### REFERENCE NUMERAL LIST

100 system
102 individual appliance
104 communication unit
106 public communication network
107 (first) communication channel
108 second communication channel
110 appliance service system
111 information element
112 user device
114 home network
124 processing unit
125 memory unit
126 processing unit
127 memory unit
128 communication unit
218 external communication unit
220 access registering module
221 individual appliance module
222 user register module
228 processing unit
229 memory unit
234 internal communication unit
236 private communication network
M1 method
M2 method
M3 method
S1-S5, S2a method steps
S6-S16 method steps
S21-S28 method steps

1. A method of providing dynamic access to a user device to appliance specific service provided by an appliance service system, the method comprising:
receiving, from the user device, via an external communication unit of the appliance service system access data, wherein the access data has been generated by the user device by reading an information element at an individual appliance and comprises a unique identifier identifying the individual appliance;
storing in an access registering module of the appliance service system an event of an access to the appliance service system using the access data associated with the individual appliance,
retrieving from the access registering module an access history using the access data associated with the individual appliance, and
in response to receiving the access data, providing access to a service level provided by the appliance service system to the user device in dependence on the access history using the access data associated with the individual appliance, wherein providing access to a service level comprises transmitting data comprising information about one or more service procedures and/or service information,
wherein the access history includes at least one out of a number of accesses using the access data and a time elapsed since a previous access using the access data.

2. The method according to claim 1, wherein providing access to a service level comprises providing access to a first service level comprising an appliance provisioning procedure or providing access to a second service level comprising an appliance maintenance procedure in dependence on the access history.

3. The method according to claim 1, wherein the provision of the service level provided by the appliance service system is further dependent on status data of the individual appliance, the status data having been received, over a communication network, by the appliance service system from the individual appliance.

4. The method according to claim 1, wherein the one or more service procedures and/or service information provided by the appliance service system as service level at an n-th time receiving the access data is different to the service level provided by the appliance service system at an m-th time receiving the access data, wherein m<n.

5. The method according to claim 1, wherein when the access data is received an n-th time with n>1, the service level provided by the appliance service system (110) is;
enabling one or more service procedures and/or service information that have not been provided at one of the previous times of receiving the access data, and/or
disabling one or more service procedures and/or service information that have been provided at one of the previous times of receiving the access data.

6. The method according to claim 1, further comprising:
storing in the access registering module of the appliance service system, in addition to the event, an indication of time of the access to the appliance service system,
retrieving from the access registering module a frequency of times and/or a period since the last or first time the appliance service system was accessed using the access data associated with the individual appliance, and
providing service information or service procedures depending on the frequency of accesses and/or depending on the period since the last or first access.

7. The method according to claim 6, wherein the method further comprises, when the frequency of access is higher than a predetermined value,
enabling one or more service procedures and/or service information that have not been provided at one of the previous times of receiving the access data, and/or
providing an information level to the user device according to an advanced user profile.

8. The method according to claim 6, wherein the method comprises, when the period since the last or first access is higher than a predetermined value,
disabling one or more service procedures and/or service information that have been provided at one of the previous times of sending the access data, and/or
providing by the appliance service system to the user device a recommendation for ordering consumables or accessories for the individual appliance.

9. The method according to claim 1, wherein the method further comprises determining whether the individual appliance is an appliance registered to a user associated with the user device in an individual appliance module of the appliance service system using the unique identifier for the individual appliance, wherein the service level provided to the user device is further dependent on the individual appliance being a registered appliance or not.

10. The method according to claim 1, wherein the method further comprises determining whether the individual appliance is an appliance connected via one or more communication networks to the external communication unit of the appliance service system, wherein the service level provided to the user device is further dependent on the individual appliance being a connected appliance or not.

11. The method according to claim 1, wherein the method further comprises determining whether the user of the individual appliance is a registered user registered in a user register module of the appliance service system, wherein the service level provided to the user device is further dependent on the user of the individual appliance being a registered user or not.

12. (canceled)

13. The method according to claim 1, wherein the information element comprises a QR code and the access data is provided by a query string of a URL obtained from the QR code.

14. The method according to claim 1, wherein the unique identifier is generated from information read from the information element.

15. The method according to claim 1, wherein the access data received by the external communication unit of the appliance service system is formed by one or more of the following included in information read from the information element at the individual appliance:
a serial number of the individual appliance,
a product number code of the individual appliance,
a model number of the individual appliance,
a maintenance level of the individual appliance,
manufacturing information,
appliance distribution information.

16. A non-volatile storage medium comprising a computer program for providing dynamic access to a user device to appliance specific service provided by an appliance service system, wherein the computer program comprises control instructions which, when executed by one or more processing units, cause the one or more processing units to perform the method according to claim 1.

17. A system for providing dynamic access to a user device to appliance specific service provided by an appliance service system, wherein the system comprises:
an appliance service system comprising a processing unit and a memory unit, wherein the memory unit comprises control instructions which, when executed by the processing unit, cause the processing unit to perform the method according to claim 1, and at least one of:
the individual appliance communicatively coupled with the appliance service system (110), or
the user device.

18. The method according to claim 1, wherein the information element is provided by a machine-readable label and the access data comprises data from reading the machine-readable label.
